(19) United States
(12) Patent Application Publication
(10) Pub. No.: US 2021/0377221 A1
(43) Pub. Date: Dec. 2, 2021

(54) Systems and Methods for Costing In Nodes after Policy Plane Convergence

(71) Applicant: Cisco Technology, Inc., San Jose, CA (US)

(72) Inventors: Amit Arvind Kadane, Sangli (IN); Baalajee Surendran, Tamil Nadu (IN); Bheema Reddy Ramidi, Telangana (IN); Dhananjaya Rao, Sunnyvale, CA (US); Ketan Jivan Talaulikar, Pune (IN); Rakesh Reddy Kandula, Bengaluru (IN)

(21) Appl. No.: 16/883,285

(22) Filed: May 26, 2020

(51) Int. Cl. H04L 29/06; H04L 12/46; H04L 29/12

(52) U.S. Cl. CPC H04L 63/0272; H04L 12/4679; H04L 63/164; H04L 61/2553; H04L 12/4683

(57) ABSTRACT

In one embodiment, a method includes activating a first network apparatus within a network and determining, by the first network apparatus, that a Scalable Group Tag (SGT) Exchange Protocol (SXP) is configured on the first network apparatus. The method also includes costing out the first network apparatus in response to determining that the SXP is configured on the first network apparatus. Costing out the first network apparatus prevents Internet Protocol (IP) traffic from flowing through the first network apparatus. The method further includes receiving, by the first network apparatus, IP-to-SGT bindings from an SXP speaker, receiving an end-of-exchange message from the SXP speaker, and costing in the first network apparatus in response to receiving the end-of-exchange message. Costing in the first network apparatus allows the IP traffic to flow through the first network apparatus.

### TECHNICAL FIELD

The present disclosure relates generally to costing in network nodes, and more specifically to systems and methods for costing in nodes after policy plane convergence.

### BACKGROUND

Scalable Group Tag (SGT) exchange protocol (SXP) is a protocol for propagating Internet Protocol (IP)-to-SGT binding information across network devices that do not have the capability to tag packets. A new SXP node may be established in a network that provides the best path for incoming traffic to reach its destination node. If the control plane of the new node converges before the policy plane, the new node will not obtain the source SGTs to add to the IP traffic or destination SGTs that are needed to apply security group access control list (SGACL) policies.

### BRIEF DESCRIPTION OF THE DRAWINGS

FIG. 1 illustrates an example system for costing in nodes after policy plane convergence using software-defined (SD) access sites connected over a Layer 3 virtual private network (L3VPN);

FIG. 2 illustrates an example system for costing in nodes after policy plane convergence using SD access sites connected over a wide area network (WAN);

FIG. 3 illustrates an example system for costing in nodes after policy plane convergence using non-SD access sites connected over a WAN;

FIG. 4 illustrates another example system for costing in nodes after policy plane convergence using non-SD access sites connected over a WAN;

FIG. 5 illustrates an example flow chart of the interaction between a policy plane, a control plane, and a data plane;

FIG. 6 illustrates an example method for costing in nodes after policy plane convergence; and

FIG. 7 illustrates an example computer system that may be used by the systems and methods described herein.

### DESCRIPTION OF EXAMPLE EMBODIMENTS

### Overview

According to an embodiment, a first network apparatus includes one or more processors and one or more computer-readable non-transitory storage media coupled to the one or more processors. The one or more computer-readable non-transitory storage media include instructions that, when executed by the one or more processors, cause the first network apparatus to perform operations including activating the first network apparatus within a network and determining that an SXP is configured on the first network apparatus. The operations also include costing out the first network apparatus in response to determining that the SXP is configured on the first network apparatus. Costing out the first network apparatus prevents IP traffic from flowing through the first network apparatus. The operations further include receiving IP-to-SGT bindings from an SXP speaker, receiving an end-of-exchange message from the SXP speaker, and costing in the first network apparatus in response to receiving the end-of-exchange message from the SXP speaker. Costing in the first network apparatus may allow the IP traffic to flow through the first network apparatus. A routing protocol may initiate costing out the first network apparatus and costing in the first network apparatus.

In certain embodiments, the first network apparatus is a first fabric border node of a first SD access site, the IP traffic flows through a second fabric border node of the first SD access site prior to costing in the first fabric border node of the first SD access site, the IP traffic is received by the second fabric border node from an edge node of the first SD access site, and the IP traffic is received by the edge node of the first SD access site from an edge node of a second SD access site using an L3VPN. The SXP speaker may be associated with a fabric border node within the second SD access site.

In some embodiments, the first network apparatus is a first fabric border node of a first SD access site, the IP traffic flows through a second fabric border node of the first SD access site prior to costing in the first fabric border node of the first SD access site, the IP traffic is received by the second fabric border node from an edge node of the first SD access site, and the IP traffic is received by the edge node of the first SD access site from an edge node of a second SD access site using a WAN. The SXP speaker may be associated with an identity services engine (ISE).

In certain embodiments, the first network apparatus is a first edge node of a first site, the IP traffic flows through a second edge node of the first site prior to costing in the first edge node of the first site, and the IP traffic is received by the second edge node from an edge node of a second site using WAN. The SXP speaker may be associated with an ISE.

In some embodiments, the first network apparatus is a first edge node of a branch office, the IP traffic flows through a second edge node of the branch office prior to costing in the first edge node of the branch office, and the IP traffic is received by the second edge node of the branch office from an edge node of a head office using WAN. The SXP speaker may be the edge node of the head office.

According to another embodiment, a method includes activating a first network apparatus within a network and determining, by the first network apparatus, that an SXP is configured on the first network apparatus. The method also includes costing out the first network apparatus in response to determining that the SXP is configured on the first network apparatus. Costing out the first network apparatus prevents IP traffic from flowing through the first network apparatus. The method further includes receiving, by the first network apparatus, IP-to-SGT bindings from an SXP speaker, receiving an end-of-exchange message from the SXP speaker, and costing in the first network apparatus in response to receiving the end-of-exchange message from the SXP speaker. Costing in the first network apparatus may allow the IP traffic to flow through the first network apparatus.

According to yet another embodiment, one or more computer-readable non-transitory storage media embody instructions that, when executed by a processor, cause the processor to perform operations including activating a first network apparatus within a network and determining that an SXP is configured on the first network apparatus. The operations also include costing out the first network apparatus in response to determining that the SXP is configured on the first network apparatus. Costing out the first network apparatus prevents IP traffic from flowing through the first network apparatus. The operations further include receiving IP-to-SGT bindings from an SXP speaker, receiving an end-of-exchange message from the SXP speaker, and costing in the first network apparatus in response to receiving the end-of-exchange message from the SXP speaker. Costing in the first network apparatus may allow the IP traffic to flow through the first network apparatus.

Technical advantages of certain embodiments of this disclosure may include one or more of the following. Certain systems and methods described herein keep a node, whose policy plane has not converged, out of the routing topology and then introduce the node into the routing topology after the node has acquired all the policy plane bindings. For example, a node may be costed out of the network in response to determining that the SXP is configured on the node and then costed back into the network in response to determining that the node received the IP-to-SGT bindings that are needed to apply the SGACL policies to incoming traffic. In certain embodiments, an end-of-exchange message is sent from one or more SXP speakers to an SXP listener (e.g., the new, costed-out network node) to indicate that each of the SXP speakers has finished sending the IP-to-SGT bindings to the SXP listener.

This approach can be applied to any method of provisioning policy plane bindings on the node. For example, this approach may be applied to SXP, Network Configuration Protocol (NETCONF), command-line interface (CLI), or any other method that provisions the mappings of flow classification parameters (e.g. source, destination, protocol, port, etc.) to the security/identity tracking mechanism (e.g., SGT). The policy plane converges when all the flow classification parameters to security/identity tracking mechanism bindings are determined and programmed by the new, upcoming node.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

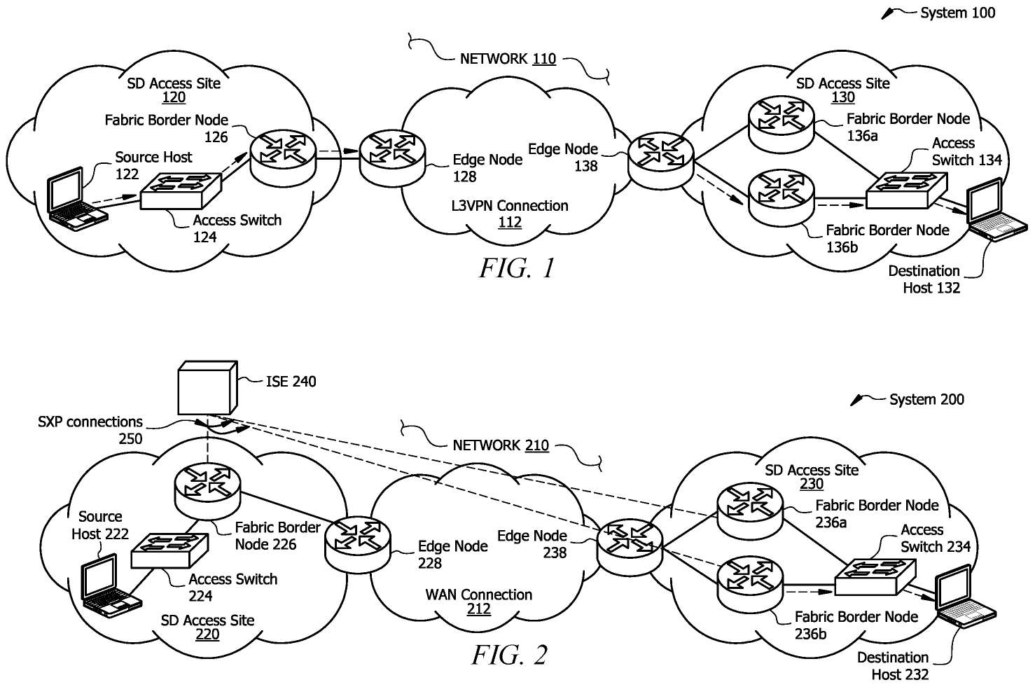

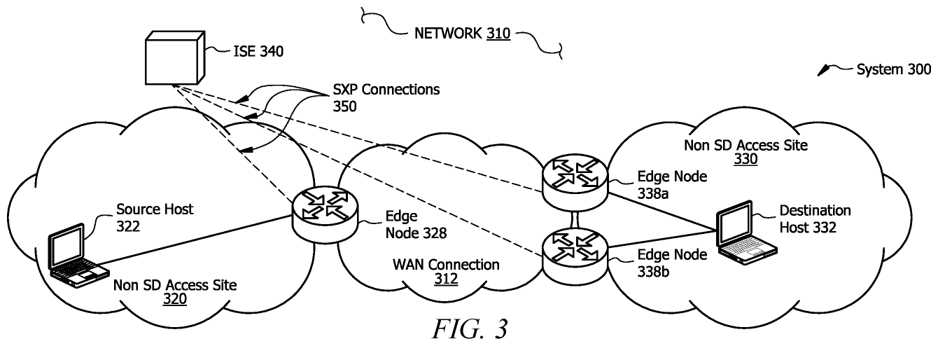

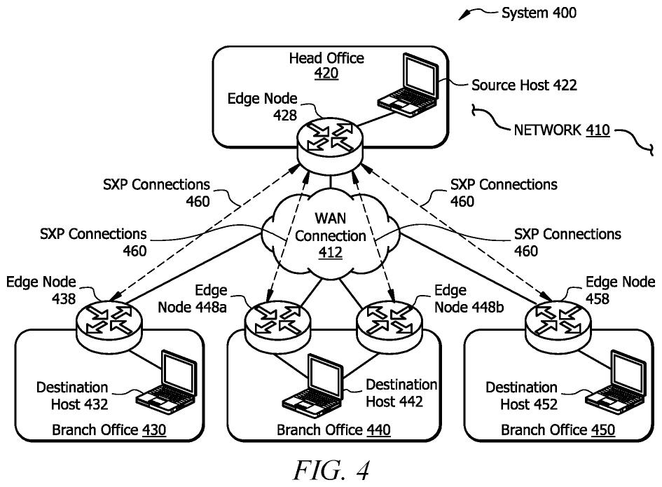

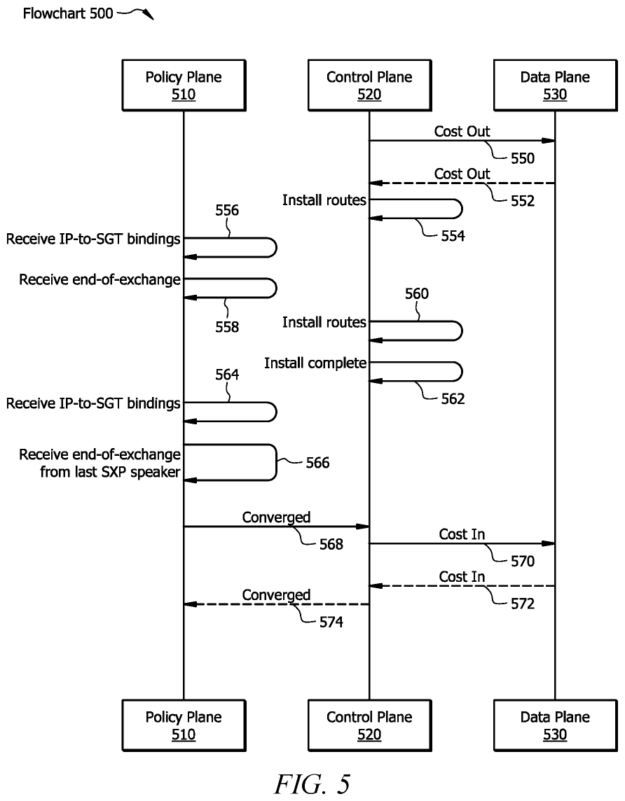

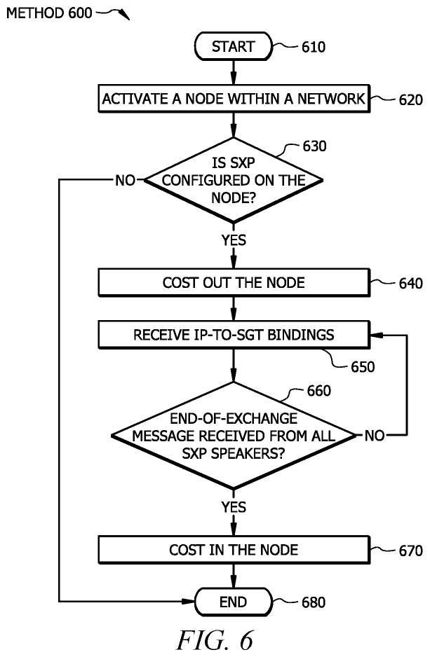

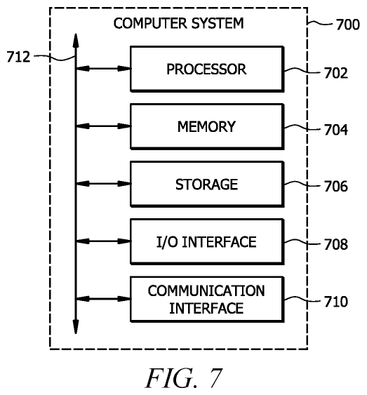

This disclosure describes systems and methods for costing in nodes after policy plane convergence. FIG. 1 shows an example system for costing in nodes after policy plane convergence using SD access sites connected over an L3VPN. FIG. 2 shows an example system for costing in nodes after policy plane convergence using SD access sites connected over a WAN. FIG. 3 shows an example system for costing in nodes after policy plane convergence using non-SD access sites connected over a WAN, and FIG. 4 shows another example system for costing in nodes after policy plane convergence using non-SD access sites connected over a WAN. FIG. 5 shows an example flow chart of the interaction between a policy plane, a control plane, and a data plane. FIG. 6 shows an example method for costing in nodes after policy plane convergence. FIG. 7 shows an example computer system that may be used by the systems and methods described herein.

FIG. 1 illustrates an example system 100 for costing in nodes after policy plane convergence using SD access sites connected over an L3VPN. System 100 or portions thereof may be associated with an entity, which may include any entity, such as a business or company that costs in nodes after policy plane convergence. The components of system 100 may include any suitable combination of hardware, firmware, and software. For example, the components of system 100 may use one or more elements of the computer system of FIG. 7. System 100 of FIG. 1 includes a network 110, an L3VPN connection 112, an SD access site 120, a source host 122, an access switch 124, a fabric border node 126, an edge node 128, an SD access site 130, a destination host 132, an access switch 134, a fabric border node 136a, a fabric border node 136b, and an edge node 138.

Network 110 of system 100 is any type of network that facilitates communication between components of system 100. Network 110 may connect one or more components of system 100. One or more portions of network 110 may include an ad-hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a combination of two or more of these, or other suitable types of networks. Network 110 may include one or more networks. Network 110 may be any communications network, such as a private network, a public network, a connection through Internet, a mobile network, a WI-FI network, etc. Network 110 may use Multiprotocol Label Switching (MPLS) or any other suitable routing technique. One or more components of system 100 may communicate over network 110. Network 110 may include a core network (e.g., the Internet), an access network of a service provider, an internet service provider (ISP) network, and the like.

In the illustrated embodiment of FIG. 1, network 110 uses L3VPN connection 112 to communicate between SD access sites 120 and 130. L3VPN connection 112 is a type of VPN mode that is built and delivered on Open Systems Interconnection (OSI) layer 3 networking technologies. Communication from the core VPN infrastructure is forwarded using layer 3 virtual routing and forwarding techniques. In certain embodiments, L3VPN 112 is an MPLS L3VPN that uses Border Gateway Protocol (BGP) to distribute VPN-related information. In certain embodiments, L3VPN 112 is used to communicate between SD access site 120 and SD access site 130.

SD access site 120 and SD access site 130 of system 100 utilize SD access technology. SD access technology may be used to set network access in minutes for any user, device, or application without compromising on security. SD access technology automates user and device policy for applications across a wireless and wired network via a single network fabric. The fabric technology may provide SD segmentation and policy enforcement based on user identity and group membership. In some embodiments, SD segmentation provides micro-segmentation for scalable groups within a virtual network using scalable group tags.

In the illustrated embodiment of FIG. 1, SD access site 120 is a source site and SD access site 130 is a destination site such that traffic moves from SD access site 120 to SD access site 130. SD access site 120 of system 100 includes source host 122, access switch 124, fabric border node 126, and edge node 128. SD access site 130 of system 100 includes destination host 132, access switch 134, fabric border node 136a, fabric border node 136b, and edge node 138.

Source host 122, access switch 124, fabric border node 126, and edge node 128 of SD access site 120 and destination host 132, access switch 134, fabric border node 136a, fabric border node 136b, and edge node 138 of SD access site 130 are nodes of system 100. Nodes are connection points within network 110 that receive, create, store and/or send traffic along a path. Nodes may include one or more endpoints and/or one or more redistribution points that recognize, process, and forward traffic to other nodes within network 110. Nodes may include virtual and/or physical nodes. In certain embodiments, one or more nodes include data equipment such as routers, servers, switches, bridges, modems, hubs, printers, workstations, and the like.

Source host 122 of SD access site 120 and destination host 132 of SD access site 130 are nodes (e.g., clients, servers, etc.) that communicate with other nodes of network 110. Source host 122 of SD access site 120 may send information (e.g., data, services, applications, etc.) to destination host 132 of SD access site 130. Each source host 122 and each destination host 132 are associated with a unique IP address. In the illustrated embodiment of FIG. 1, source host 122 communicates a packet to access switch 124.

Access switch 124 of SD access site 120 and access switch 134 of SD access site 130 are components that connect multiple devices within network 110. Access switch 124 and access switch 134 each allow connected devices to share information and communicate with each other. In certain embodiments, access switch 124 modifies the packet received from source host 122 to add an SGT. The SGT is a tag that may be used to segment different users/resources in network 110 and apply policies based on the different users/resources. The SGT is understood by the components of system 100 and may be used to enforce policies on the traffic. In certain embodiments, the source SGT is carried natively within SD access site 120 and SD access site 130. For example, the source SGT may be added by access switch 124 of SD access site 120, removed by fabric border node 126 of SD access site 120, and later added back in by fabric border node 136a and/or fabric border node 136b of SD access site 130. The SGT may be carried natively in a Virtual eXtensible Local Area Network (VxLAN) header within SD access site 120. In the illustrated embodiment of FIG. 1, access switch 124 communicates the modified VxLAN packet to fabric border node 126.

Fabric border node 126 of SD access site 120 is a device (e.g., a core device) that connects external networks (e.g., external L3 networks) to the fabric of SD access site 120. Fabric border nodes 136a and 136b of SD access site 130 are devices (e.g., core devices) that connect external networks (e.g., external L3 networks) to the fabric of SD access site 130. In the illustrated embodiment of FIG. 1, fabric border node 126 receives the modified VxLAN packet from access switch 124. Since SGT cannot be carried natively from SD access site 120 to SD access site 130 across L3VPN connection 112, fabric border node 126 removes the SGT. Fabric border node 126 then communicates the modified packet, without the SGT, to edge node 128.

Edge node 128 of SD access site 120 is a network component that serves as a gateway between SD access site 120 and an external network (e.g., an L3VPN network). Edge node 138 of SD access site 130 is a network component that serves as a gateway between SD access site 130 and an external network (e.g., an L3VPN network). In the illustrated embodiment of FIG. 1, edge node 128 receives the modified packet, without the SGT, from fabric border node 126 and communicates the modified packet to edge node 138 of SD access site 130 via L3VPN connection 112.

When fabric border node 136a of SD access site 130 is the only fabric border node in SD access site 130, edge node 138 communicates the modified packet to fabric border node 136a. Fabric border node 136a re-adds the SGT to the packet based on IP-to-SGT bindings. IP-to-SGT bindings are used to bind IP traffic to SGTs. Fabric border node 136a may determine the IP-to-SGT bindings using SXP running between fabric border node 126 and fabric border node 136a. SXP is a protocol that is used to propagate SGTs across network devices. Once fabric border node 136a determines the IP-to-SGT bindings, fabric border node 136a can use the IP-to-SGT bindings to obtain the source SGT and add the source SGT to the packet. Access switch 134 can then apply SGACL policies to traffic using the SGTs.

When fabric border node 136b is activated (e.g., comes up for the first time, is reloaded, etc.) in SD access site 130, fabric border node 136b may provide the best path to reach destination host 132 from edge node 138. If the control plane converges before the policy plane in fabric border node 136b, then edge node 138 will switch the traffic to fabric border node 136b before fabric border node 136b determines the IP-to-SGT bindings from fabric border node 126 that are needed by fabric border node 136b to add SGTs to the IP traffic. In this scenario, the proper SGTs will not be added to the traffic in fabric border node 136b, and the SGACL policies will not be applied to the traffic in access switch 134.

In more general terms, if the source and/or destination SGT is not known, the traffic will not be matched against the SGACL policy meant for a particular “known source SGT” to a particular “known destination SGT.” Rather, the traffic may be matched against a “catch all” or “aggregate/default” policy that may not be the same as the intended SGACL policy. This may result in one of the following undesirable actions: (1) denying traffic when the traffic should be permitted; (2) permitting traffic when the traffic should be denied; or (3) incorrectly classifying and/or servicing the traffic.

Effective synchronization between the policy plane and the routing plane may be used to ensure that all IP-to-SGT bindings that are needed by fabric border node 136b to add the SGTs to incoming traffic are determined (e.g., learned) and programmed by fabric border node 136b prior to routing traffic through fabric border node 136b. In certain embodiments, if the policy plane is enabled, the routing protocol costs fabric border node 136b out on bring-up until the policy plane has converged (i.e., all the bindings that are needed by fabric border node 136b to add the SGTs to incoming traffic are determined and programmed). The routing protocol then costs fabric border node 136b in after the policy plane has converged. These steps collectively ensure that the correct identity is added to the traffic when the traffic starts flowing through newly coming up fabric border node 136b, thereby ensuring that the correct policies are applied to the traffic.

In operation, source host 122 of SD access site 120 communicates traffic to access switch 124 of SD access site 120. Access switch 124 adds SGTs to the traffic and communicates the traffic and corresponding SGTs to fabric border node 126 of SD access site 120. Since the SGTs cannot be carried natively across L3VPN connection 112, fabric border node 126 removes the SGTs and communicates the traffic, without the SGTs, to edge node 128. Edge node 128 of source SD access site 120 communicates the traffic to edge node 138 of destination SD access site 130. Edge node 138 communicates the traffic to fabric border node 136a, and fabric border node 136a re-adds the SGTs to the traffic. Fabric border node 136a communicates the traffic, with the SGTs, to access switch 134, and access switch 134 communicates the traffic to destination host 132.

Fabric border node 136b is then activated in SD access site 130. Fabric border node 136b provides the best path to reach destination host 132 from edge node 138. In response to determining that SXP is configured on fabric border node 136b, the routing protocol costs out fabric border node 136b. Sine costing out fabric border node 136b prevents IP traffic from flowing through fabric border node 136b, the traffic continues to flow through fabric border node 136a. Fabric border node 136b (e.g., an SXP listener) receives IP-to-SGT bindings from fabric border node 126 (e.g., an SXP speaker) of SD access site 120. Fabric border node 136b then receives an end-of-exchange message from fabric border node 126, which indicates that fabric border node 126 has finished sending the IP-to-SGT bindings to fabric border node 136b. In response to fabric border node 136b receiving the end-of-exchange message from fabric border node 126, the routing protocol costs in fabric border node 136b. Once fabric border node 136b is costed in, edge node 138 switches the traffic from fabric border node 136a to fabric border node 136b. As such, by ensuring that the policy plane has converged before routing traffic through fabric border node 136b, fabric border node 136b can use the IP-to-SGT bindings to add the proper SGTs to the traffic, which allows access switch 134 to apply the SGACL policies to incoming traffic based on the source and/or destination SGTs.

Although FIG. 1 illustrates a particular arrangement of network 110, L3VPN connection 112, SD access site 120, source host 122, access switch 124, fabric border node 126, edge node 128, SD access site 130, destination host 132, access switch 134, fabric border node 136a, fabric border node 136b, and edge node 138, this disclosure contemplates any suitable arrangement of network 110, L3VPN connection 112, SD access site 120, source host 122, access switch 124, fabric border node 126, edge node 128, SD access site 130, destination host 132, access switch 134, fabric border node 136a, fabric border node 136b, and edge node 138.

Although FIG. 1 illustrates a particular number of networks 110, L3VPN connections 112, SD access sites 120, source hosts 122, access switches 124, fabric border nodes 126, edge nodes 128, SD access sites 130, destination hosts 132, access switches 134, fabric border nodes 136a, fabric border nodes 136b, and edge nodes 138, this disclosure contemplates any suitable number of networks 110, L3VPN connections 112, SD access sites 120, source hosts 122, access switches 124, fabric border nodes 126, edge nodes 128, SD access sites 130, destination hosts 132, access switches 134, fabric border nodes 136a, fabric border nodes 136b, and edge nodes 138.

FIG. 2 illustrates an example system 200 for costing in nodes after policy plane convergence using SD access sites connected over WAN. System 200 or portions thereof may be associated with an entity, which may include any entity, such as a business or company that costs in nodes after policy plane convergence. The components of system 200 may include any suitable combination of hardware, firmware, and software. For example, the components of system 200 may use one or more elements of the computer system of FIG. 7. System 200 of FIG. 2 includes a network 210, a WAN connection 212, an SD access site 220, a source host 222, an access switch 224, a fabric border node 226, an edge node 228, an SD access site 230, a destination host 232, an access switch 234, a fabric border node 236a, a fabric border node 236b, an edge node 238, an ISE 240, and SXP connections 250.

Network 210 of system 200 is any type of network that facilitates communication between components of system 200. Network 210 may connect one or more components of system 200. One or more portions of network 210 may include an ad-hoc network, an intranet, an extranet, a VPN, a LAN, a WLAN, a WAN, a WWAN, a MAN, a portion of the Internet, a portion of the PSTN, a cellular telephone network, a combination of two or more of these, or other suitable types of networks. Network 210 may include one or more networks. Network 210 may be any communications network, such as a private network, a public network, a connection through Internet, a mobile network, a WI-FI network, etc. Network 210 may use MPLS or any other suitable routing technique. One or more components of system 200 may communicate over network 210. Network 210 may include a core network (e.g., the Internet), an access network of a service provider, an ISP network, and the like. In the illustrated embodiment of FIG. 2, network 210 uses WAN connection 212 to communicate between SD access site 220 and SD access site 230.

SD access site 220 and SD access site 230 of system 200 utilize SD access technology. In the illustrated embodiment of FIG. 2, SD access site 220 is the source site and SD access site 230 is the destination site such that traffic flows from SD access site 220 to SD access site 230. SD access site 220 of system 200 includes source host 222, fabric border node 226, and edge node 228. SD access site 230 of system 200 includes destination host 232, fabric border node 236a, fabric border node 236b, and edge node 238. Source host 222, fabric border node 226, and edge node 228 of SD access site 220 and destination host 232, fabric border node 236a, fabric border node 236b, and edge node 238 of SD access site 230 are nodes of system 200.

Source host 222 of SD access site 220 and destination host 232 of SD access site 230 are nodes (e.g., clients, servers, etc.) that communicate with other nodes of network 210. Source host 222 of SD access site 220 may send traffic (e.g., data, services, applications, etc.) to destination host 232 of SD access site 230. Each source host 222 and each destination host 232 are associated with a unique IP address. In the illustrated embodiment of FIG. 2, source host 222 communicates traffic to fabric border node 226.

Access switch 224 of SD access site 220 and access switch 234 of SD access site 230 are components that connect multiple devices within network 210. Access switch 224 and access switch 234 each allow connected devices to share information and communicate with each other. In certain embodiments, access switch 224 modifies the packet received from source host 222 to add an SGT. The SGT is a tag that may be used to segment different users/resources in network 210 and apply policies based on the different users/resources. The SGT is understood by the components of system 200 and may be used to enforce policies on the traffic. In certain embodiments, the source SGT is carried natively within SD access site 220, over WAN connection 212, and/or natively within SD access site 230. For example, the source SGT may be added by access switch 224 of SD access site 220. In the illustrated embodiment of FIG. 2, access switch 224 communicates the modified packet to fabric border node 226.

Fabric border node 226 of SD access site 220 is a device (e.g., a core device) that connects external networks to the fabric of SD access site 220. Fabric border nodes 236a and 236b of SD access site 230 are devices (e.g., core devices) that connect external networks (to the fabric of SD access site 230. In the illustrated embodiment of FIG. 2, fabric border node 226 obtains destination SGTs from IP-to-SGT bindings determined from ISE 240 using SXP connections 250. ISE 240 is an external identity services engine that is leveraged for dynamic endpoint to group mapping and/or policy definition. In certain embodiments, the source SGTs are carried natively in the traffic. For example, the source SGTs may be carried natively in the command header of an Ethernet frame, in IP security (IPSEC) metadata, in a VxLAN header, and the like. Fabric border node 226 communicates traffic received from source host 222 to edge node 228.

Edge node 228 of SD access site 220 is a network component that serves as a gateway between SD access site 220 and an external network (e.g., a WAN network). Edge node 238 of SD access site 230 is a network component that serves as a gateway between SD access site 230 and an external network (e.g., a WAN network). In the illustrated embodiment of FIG. 2, edge node 228 of SD access site 220 receives traffic from fabric border node 226 and communicates the traffic to edge node 238 of SD access site 230 via WAN connection 212.

When fabric border node 236a of SD access site 230 is the only fabric border node in SD access site 230, edge node 238 communicates the traffic to fabric border node 236a. Fabric border node 236a obtains destination SGTs from IP-to-SGT bindings determined from ISE 240 using SXP connections 250. Once fabric border node 236a receives the IP-to-SGT bindings from ISE 240, fabric border node 236a can use the IP-to-SGT bindings to apply SGACL policies to traffic.

When fabric border node 236b is activated (e.g., comes up for the first time, is reloaded, etc.) in SD access site 230, fabric border node 236b may provide the best path to reach destination host 232 from edge node 238. If the control plane converges before the policy plane in fabric border node 236b, then edge node 238 will switch the traffic to fabric border node 236b before fabric border node 236b receives the IP-to-SGT bindings from ISE 240. In this scenario, the destination SGTs will not be obtained by fabric border node 236b, and therefore the correct SGACL policies will not be applied to the traffic.

Effective synchronization between the policy plane and the routing plane may be used to ensure that all IP-to-SGT bindings that are needed by fabric border node 236b to obtain the destination SGTs are determined and programmed by fabric border node 236b prior to routing traffic through fabric border node 236b. In certain embodiments, if the policy plane is enabled, the routing protocol costs fabric border node 236b out on bring-up until the policy plane has converged (i.e., all the bindings that are needed by fabric border node 136b to obtain the destination SGTs are determined and programmed). The routing protocol then costs fabric border node 236b in after the policy plane has converged. These steps collectively ensure that the correct destination SGTs are available when the traffic starts flowing through newly coming up fabric border node 236b, thereby ensuring that the correct policies are applied to the traffic.

In operation, source host 222 of SD access site 220 communicates traffic to fabric border node 226 of SD access site 220. Fabric border node 226 then communicates the traffic to edge node 228. Edge node 228 of source SD access site 220 communicates the traffic to edge node 238 of destination SD access site 230. Edge node 238 communicates the traffic to fabric border node 236a. Fabric border node 236a obtains destination SGTs from IP-to-SGT bindings determined from ISE 240 using SXP connections 250 and uses the destination SGTs to apply SGACL policies to the traffic. Fabric border node 236a communicates the traffic to destination host 232.

Fabric border node 236b is then activated in SD access site 230. Fabric border node 236b provides the best path to reach destination host 232 from edge node 238. In response to determining that SXP is configured on fabric border node 236b, the routing protocol costs out fabric border node 236b. Sine costing out fabric border node 236b prevents IP traffic from flowing through fabric border node 236b, the traffic continues to flow through fabric border node 236a. Fabric border node 236b (e.g., SXP listener) receives IP-to-SGT bindings from ISE 240 (e.g., SXP speaker) using SXP connections 250. After ISE 240 has communicated all IP-to-SGT bindings to fabric border node 236b, ISE 240 sends an end-of-exchange message to fabric border node 236b. In response to fabric border node 236b receiving the end-of-exchange message, the routing protocol costs in fabric border node 236b. Once fabric border node 236b is costed in, edge node 238 switches the traffic from fabric border node 236a to fabric border node 236b. As such, by ensuring that the policy plane has converged before routing traffic through fabric border node 236b, fabric border node 236b can obtain the destination SGTs and use the destination SGTs to apply the appropriate SGACL policies to incoming traffic.

Although FIG. 2 illustrates a particular arrangement of network 210, WAN connection 212, SD access site 220, source host 222, access switch 224, fabric border node 226, edge node 228, SD access site 230, destination host 232, access switch 234, fabric border node 236a, fabric border node 236b, and edge node 238, this disclosure contemplates any suitable arrangement of network 210, WAN connection 212, SD access site 220, source host 222, access switch 224, fabric border node 226, edge node 228, SD access site 230, destination host 232, access switch 234, fabric border node 236a, fabric border node 236b, and edge node 238.

Although FIG. 2 illustrates a particular number of networks 210, WAN connections 212, SD access sites 220, source hosts 222, access switches 224, fabric border nodes 226, edge nodes 228, SD access sites 230, destination hosts 232, access switches 234, fabric border nodes 236a, fabric border nodes 236b, and edge nodes 238, this disclosure contemplates any suitable number of networks 210, WAN connections 212, SD access sites 220, source hosts 222, access switches 224, fabric border nodes 226, edge nodes 228, SD access sites 230, destination hosts 232, access switches 234, fabric border nodes 236a, fabric border nodes 236b, and edge nodes 238.

FIG. 3 illustrates an example system 300 for costing in nodes after policy plane convergence using non-SD access sites connected over a WAN. System 300 or portions thereof may be associated with an entity, which may include any entity, such as a business or company that costs in nodes after policy plane convergence. The components of system 300 may include any suitable combination of hardware, firmware, and software. For example, the components of system 300 may use one or more elements of the computer system of FIG. 7. System 300 of FIG. 3 includes a network 310, a WAN connection 312, a site 320, a source host 322, an edge node 328, a site 330, a destination host 332, an edge node 338a, an edge node 338b, an ISE 340, and SXP connections 350.

Network 310 of system 300 is any type of network that facilitates communication between components of system 300. Network 310 may connect one or more components of system 300. One or more portions of network 310 may include an ad-hoc network, an intranet, an extranet, a VPN, a LAN, a WLAN, a WAN, a WWAN, a MAN, a portion of the Internet, a portion of the PSTN, a cellular telephone network, a combination of two or more of these, or other suitable types of networks. Network 310 may include one or more networks. Network 310 may be any communications network, such as a private network, a public network, a connection through Internet, a mobile network, a WI-FI network, etc. Network 310 may use MPLS or any other suitable routing technique. One or more components of system 300 may communicate over network 310. Network 310 may include a core network (e.g., the Internet), an access network of a service provider, an ISP network, and the like. In the illustrated embodiment of FIG. 3, network 310 uses WAN connection 312 to communicate between site 320 and site 330.

Site 320 of system 300 is a source site and site 330 of system 300 is a destination site such that traffic flows from site 320 to site 330. In the illustrated embodiment of FIG. 3, site 320 and site 330 are not SD access sites. Site 320 includes source host 322 and edge node 328. Site 330 includes destination host 332, edge node 338a, and edge node 338b. Source host 322 and edge node 328 of site 320 and destination host 332, edge node 338a, and edge node 338b of site 330 are nodes of system 300.

Source host 322 of site 320 and destination host 332 of site 330 are nodes (e.g., clients, servers, etc.) that communicate with other nodes of network 310. Source host 322 of site 320 may send traffic (e.g., data, services, applications, etc.) to destination host 332 of site 330. Each source host 322 and each destination host 332 are associated with a unique IP address. In the illustrated embodiment of FIG. 3, source host 322 communicates traffic to edge node 328. Edge node 328 of site 320 is a network component that serves as a gateway between site 320 and an external network (e.g., a WAN network). In certain embodiments, edge node 328 adds the source SGTs to the traffic. Edge node 338a and edge node 338b of site 330 are network components that serve as gateways between site 330 and an external network (e.g., a WAN network). Edge node 338a and edge node 338b obtain destination SGTs from ISE 340 using SXP connections 350. Edge node 338a and edge node 338b use the destination SGTs to apply SGACL policies to the traffic. ISE 340 is an external identity services engine that is leveraged for dynamic endpoint to group mapping and/or policy definition. In certain embodiments, the source SGTs are carried natively in IPSEC metadata over WAN connection 312.

When edge node 338a of site 330 is the only edge node in site 330, edge node 328 of site 320 communicates the traffic to edge node 338a. Once edge node 338b is activated (e.g., comes up for the first time, is reloaded, etc.) in site 330, edge node 338b may provide the best path to reach destination host 332. If the control plane converges before the policy plane in edge node 338b, then edge node 328 of site 320 will switch the traffic to edge node 338b of site 330 before edge node 338b determines the IP-to-SGT bindings from ISE 340. In this scenario, the proper destination SGTs will not be obtained by edge node 338b, and the SGACL policies will not be applied to the traffic in edge node 338b.

Effective synchronization between the policy plane and the routing plane may be used to ensure that all IP-to-SGT bindings that are needed by edge node 338b to obtain the destination SGTs are determined and programmed by edge node 338b prior to routing traffic through edge node 338b. In certain embodiments, if the policy plane is enabled, the routing protocol costs edge node 338b out on bring-up until the policy plane has converged (i.e., all the bindings that are needed by edge node 338b to obtain the destination SGTs are determined and programmed). The routing protocol then costs edge node 338b in after the policy plane has converged. These steps collectively ensure that the correct destination SGTs are available when the traffic starts flowing through newly coming up edge node 338b, thereby ensuring that the correct policies are applied to the traffic.

In operation, source host 322 of site 320 communicates traffic to edge node 328 of site 320. Source SGTs are obtained by edge node 328 using the IP-to-SGT bindings determined (e.g., learned) from ISE 340 using SXP connection 350. Edge node 328 of source site 320 communicates the traffic to edge node 338a of destination site 330. Edge node 338a obtains the destination SGTs using the IP-to-SGT bindings determined from ISE 340 using SXP connection 350. Edge node 338a uses the destination SGTs to apply the appropriate SGACL policies to the traffic and communicates the traffic to destination host 332.

Edge node 338b is then activated in destination site 330. Edge node 338b provides the best path to reach destination host 332 from edge node 328 of site 320. In response to determining that SXP is configured on edge node 338b, the routing protocol costs out edge node 338b. Sine costing out edge node 338b prevents IP traffic from flowing through edge node 338b, the traffic continues to flow through edge node 338a. Edge node 338b determines the IP-to-SGT bindings from ISE 340 using SXP connection 350. In response to determining the IP-to-SGT bindings, the routing protocol costs in edge node 338b. Once edge node 338b is costed in, edge node 328 switches the traffic from edge node 338a to edge node 338b. As such, by ensuring that the policy plane has converged before routing traffic through edge node 338b, edge node 338b applies the appropriate SGACL policies to the traffic.

Although FIG. 3 illustrates a particular arrangement of network 310, WAN connection 312, site 320, source host 322, edge node 328, site 330, destination host 332, edge node 338a, and edge node 338b, this disclosure contemplates any suitable arrangement of network 310, WAN connection 312, site 320, source host 322, edge node 328, site 330, destination host 332, edge node 338a, and edge node 338b.

Although FIG. 3 illustrates a particular number of networks 310, WAN connections 312, sites 320, source hosts 322, edge nodes 328, sites 330, destination hosts 332, edge nodes 338a, and edge nodes 338b, this disclosure contemplates any suitable number of networks 310, WAN connections 312, sites 320, source hosts 322, edge nodes 328, sites 330, destination hosts 332, edge nodes 338a, and edge nodes 338b.

FIG. 4 illustrates another example system 400 for costing in nodes after policy plane convergence using non-SD access sites connected over a WAN. System 400 or portions thereof may be associated with an entity, which may include any entity, such as a business or company that costs in nodes after policy plane convergence. The components of system 400 may include any suitable combination of hardware, firmware, and software. For example, the components of system 400 may use one or more elements of the computer system of FIG. 7. System 400 of FIG. 4 includes a network 410, a WAN connection 412, a head office 420, a source host 422, an edge node 428, a branch office 430, a destination host 432, an edge node 438, a branch office 440, a destination host 442, an edge node 448a, an edge node 448b, a branch office 450, a destination host 452, an edge node 458, and SXP connections 460.

Network 410 of system 400 is any type of network that facilitates communication between components of system 400. Network 410 may connect one or more components of system 400. One or more portions of network 410 may include an ad-hoc network, an intranet, an extranet, a VPN, a LAN, a WLAN, a WAN, a WWAN, a MAN, a portion of the Internet, a portion of the PSTN, a cellular telephone network, a combination of two or more of these, or other suitable types of networks. Network 410 may include one or more networks. Network 410 may be any communications network, such as a private network, a public network, a connection through Internet, a mobile network, a WI-FI network, etc. Network 410 may use MPLS or any other suitable routing technique. One or more components of system 400 may communicate over network 410. Network 410 may include a core network (e.g., the Internet), an access network of a service provider, an ISP network, and the like. In the illustrated embodiment of FIG. 4, network 410 uses WAN connection 412 to communicate between head office 420 and branch offices 430, 440, and 450.

Head office 420 of system 400 is a source site, and branch offices 430, 440, and 450 of system 400 are destination sites. Head office 420 includes source host 422 and edge node 428. Branch office 430 includes destination host 432 and edge node 438, branch office 440 includes destination host 442, edge node 448a, and edge node 448b, and branch office 450 includes destination host 452 and edge node 458.

Source host 422 of head office 420, destination host 432 of branch office 430, destination host 442 of branch office 440, and destination host 452 of branch office 450 are nodes (e.g., clients, servers, etc.) that communicate with other nodes of network 410. Source host 422 of head office 420 may send traffic (e.g., data, services, applications, etc.) to destination host 432 of branch office 430, destination host 442 of branch office 440, and/or destination host 452 of branch office 450. Each source host 422 and each destination host 432, 442, and 452 are associated with a unique IP address. In the illustrated embodiment of FIG. 4, source host 422 communicates traffic to edge node 428. Edge node 428 of head office 420 is a network component that serves as a gateway between head office 420 and an external network (e.g., a WAN network). Edge node 438 of branch office 430, edge nodes 448a and 448b of branch office 440, and edge node 458 of branch office 450 are network components that serve as gateways between branch office 430, branch office 440, and branch office 450 respectively, and an external network (e.g., a WAN network).

In certain embodiments, edge node 428 of head office 420 acts as an SXP reflector for the IP-to-SGT bindings received from branch offices 430, 440, and 450. When edge node 448a of branch office 440 is the only edge node in branch office 440, edge node 428 of head office 420 communicates the traffic to edge node 448a. Once edge node 448b is activated (e.g., comes up for the first time, is reloaded, etc.) in branch office 440, edge node 448b may provide the best path to reach destination host 442. If the control plane converges before the policy plane in edge node 448b, then edge node 428 of head office 420 will switch the traffic to edge node 448b of branch office 440 before edge node 448b determines the IP-to-SGT bindings from edge node 428. In this scenario, the SGTs associated with the source and destination TPs will not be available in edge node 448b, and the correct SGACL policies will not be applied to the traffic in edge node 448b.

Effective synchronization between the policy plane and the routing plane may be used to ensure that all IP-to-SGT bindings that are needed by edge node 448b to obtain the source and destination SGTs are determined and programmed by edge node 448b prior to routing traffic through edge node 448b. In certain embodiments, if the policy plane is enabled, the routing protocol costs edge node 448b out on bring-up until the policy plane has converged (i.e., all the bindings that are needed by edge node 448b to obtain the source and destination SGTs are determined and programmed). The routing protocol then costs edge node 448b in after the policy plane has converged. These steps collectively ensure that the source and destination SGTs are available when the traffic starts flowing through newly coming up edge node 448b, thereby ensuring that the correct policies are applied to the traffic.

In operation, source host 422 of head office 420 communicates traffic to edge node 428 of head office 420. Edge node 428 acts as an SXP reflector to reflect the IP-to-SGT bindings between branch offices 430, 440, and 450 via SXP connections 460. Edge node 428 of head office 420 communicates the traffic to edge node 448a of branch office 440. Edge node 448a obtains SGTs from edge node 428 of head office 420. Edge node 448a communicates the traffic to destination host 442.

Edge node 448b is then activated in branch office 440. Edge node 448b provides the best path within branch office 440 to reach destination host 442 from edge node 428 of head office 420. In response to determining that SXP is configured on edge node 448b, the routing protocol costs out edge node 448b. Sine costing out edge node 448b prevents IP traffic from flowing through edge node 448b, the traffic continues to flow through edge node 448a. Edge node 448b determines IP-to-SGT bindings from edge node 428 using SXP connections 460. In response to determining the IP-to-SGT bindings, the routing protocol costs in edge node 448b. Once edge node 448b is costed in, edge node 428 switches the traffic from edge node 448a to edge node 448b. As such, by ensuring that the policy plane has converged before routing traffic through edge node 448b, edge node 448b applies the appropriate SGACL policies to incoming traffic.

Although FIG. 4 illustrates a particular arrangement of network 410, WAN connection 412, head office 420, source host 422, edge node 428, branch office 430, destination host 432, edge node 438, branch office 440, destination host 442, edge node 448a, edge node 448b, branch office 450, destination host 452, edge node 458, and SXP connections 460, this disclosure contemplates any suitable arrangement of network 410, WAN connection 412, head office 420, source host 422, edge node 428, branch office 430, destination host 432, edge node 438, branch office 440, destination host 442, edge node 448a, edge node 448b, branch office 450, destination host 452, edge node 458, and SXP connections 460.

Although FIG. 4 illustrates a particular number of networks 410, WAN connections 412, head offices 420, source hosts 422, edge nodes 428, branch offices 430, destination hosts 432, edge nodes 438, branch offices 440, destination hosts 442, edge nodes 448a, edge nodes 448b, branch offices 450, destination hosts 452, edge nodes 458, and SXP connections 460, this disclosure contemplates any suitable number of networks 410, WAN connections 412, head offices 420, source hosts 422, edge nodes 428, branch offices 430, destination hosts 432, edge nodes 438, branch offices 440, destination hosts 442, edge nodes 448a, edge nodes 448b, branch offices 450, destination hosts 452, edge nodes 458, and SXP connections 460. For example, system 400 may include more or less than three branch offices.

FIG. 5 illustrates an example flow chart 500 of the interaction between a policy plane 510, a control plane 520, and a data plane 530. Policy plane 510 includes the settings, protocols, and tables for the network devices that provide policy constructs of the network. In SD access networks (e.g., network 110 of FIG. 1), policy plane 510 includes the settings, protocols, and tables for fabric-enabled devices that provide the policy constructs of the fabric overlay. Control plane 520, also known as the routing plane, is the part of the router architecture that is concerned with drawing the network topology. Control plane 520 may generate one or more routing tables that define what actions to perform with incoming traffic. Control plane 520 participates in routing protocols. Control plane 520 is the part of the software that configures and shuts down data plane 530. In SD access networks, control plane 520 includes the settings, protocols, and tables for fabric-enabled devices that provide the logical forwarding constructs of the network fabric overlay. Data plane 530, also known as the forwarding plane, is the part of the software that processes data request. In SD access networks, data plane 530 may be a specialized IP/User Datagram Protocol (UDP)-based frame encapsulation that includes the forwarding and policy constructs for the fabric overlay.

Flow chart 500 begins at step 550, where control plane 520 instructs data plane 530 to cost out a node (e.g., fabric border node 136b of FIG. 1) from a network (e.g., network 110 of FIG. 1). In certain embodiments, control plane 520 instructs data plane 530 to cost out the node if the policy plane is enabled. For example, control plane 520 may instruct data plane 530 to cost out the node if SXP is configured on the node.

At step 552 of flow chart 500, data plane 530 notifies control plane 520 that data plane 530 has costed out the node. Costing out the node prevents IP traffic from flowing through the node. At step 554, control plane 520 installs routes on the new node. For example, a routing protocol may select its own set of best routes and installs those routes and their attributes in a routing information base (RIB) on the new node. At step 556, policy plane 510 receives IP-to-SGT bindings from a first SXP speaker. In certain embodiments, after the first SXP speaker (e.g., fabric border node 126 of FIG. 1) sends all IP-to-SGT bindings to an SXP listener (e.g., fabric border node 136b of FIG. 1), the first SXP speaker sends an end-of-exchange message to the SXP listener. At step 558, policy plane 510 receives the end-of-exchange message. For example, the SXP listener may receive the end-of-exchange message from the first SXP speaker. At step 560, control plane 520 installs additional routes on the new node. At step 562, control plane 520 indicates that the installation is complete.

At step 564 of flow chart 500, policy plane 510 receives IP-to-SGT bindings from the remaining SXP speakers. In certain embodiments, after the last SXP speaker (e.g., fabric border node 126 of FIG. 1) sends all IP-to-SGT bindings to the SXP listener (e.g., fabric border node 136b of FIG. 1), the last SXP speaker sends an end-of-exchange message to the SXP listener. At step 566, policy plane 510 receives the end-of-exchange message from the last SXP speaker. For example, the SXP listener may receive the end-of-exchange message from the last SXP speaker.

At step 568 of flow chart 500, policy plane 510 notifies control plane 520 that policy plane 510 has converged. Policy plane 510 is considered converged when the new node determines the IP-to-SGT bindings that are required to add the SGTs and/or apply SGACL policies. At step 570, control plane 520 instructs data plane 530 to cost in the node (e.g., fabric border node 136b of FIG. 1). In certain embodiments, control plane 520 instructs data plane 530 to cost in the node in response to determining that policy plane 510 has converged. At step 572, data plane 530 notifies control plane 520 that data plane 530 has costed in the node. Costing in the node allows IP traffic from flowing through the node. At step 574, control plane 520 notifies policy plane 510 that, in response to policy plane 510 converging, the node has been costed in.

Although this disclosure describes and illustrates particular steps of flow chart 500 of FIG. 5 as occurring in a particular order, this disclosure contemplates any suitable steps of the flow chart 500 of FIG. 5 occurring in any suitable order. Moreover, although this disclosure describes and illustrates an example flow chart 500 that shows the interaction between policy plane 510, control plane 520, and data plane 530, including the particular steps of flow chart 500 of FIG. 5, this disclosure contemplates any suitable flow chart 500 that shows the interaction between policy plane 510, control plane 520, and data plane 530, including any suitable steps, which may include all, some, or none of the steps of flow chart 500 of FIG. 5, where appropriate. Furthermore, although this disclosure describes and illustrates particular components, devices, or systems carrying out particular steps of flow chart 500 of FIG. 5, this disclosure contemplates any suitable combination of any suitable components, devices, or systems carrying out any suitable steps of flow chart 500 of FIG. 5.

FIG. 6 illustrates an example method 600 for costing in nodes after policy plane convergence. Method 600 begins at step 610. At step 620, a first node (e.g., fabric border node 136b of FIG. 1) is activated within a network (e.g., network 110 of FIG. 1). In certain embodiments, the first node may be activated (e.g., brought up, reloaded, etc.) in a first SD access site (e.g., SD access site 130 of FIG. 1) within the network. The first SD access site may include a second node (e.g., fabric border node 136a of FIG. 1) and one or more edge nodes (e.g., edge node 138 of FIG. 1). The edge node of the first SD access site may direct traffic received from a second SD access site through the second node of the first SD access site. Method 600 then moves from step 620 to step 630.

At step 630, method 600 determines whether SXP is configured on the first node. If SXP is not configured on the first node, method 600 moves from step 630 to step 680, where method 600 ends. If, at step 630, method 600 determines that SXP is configured on the first node, method 600 moves from step 630 to step 640, where a routing protocol costs out the first node. Costing out the node prevents IP traffic from flowing through the first node. Method 600 then moves from step 640 to step 650.

At step 650 of method 600, the first node (e.g., an SXP listener) receives IP-to-SGT bindings from one or more SXP speakers. The IP-to-SGT bindings may be received from the second node (e.g., fabric border node 126 of FIG. 1), by an ISE (e.g., ISE 240 of FIG. 2 or ISE 340 of FIG. 3), and the like. The first node may receive the IP-to-SGT bindings using one or more SXP connections. Method 600 then moves from step 650 to step 660, where the first node determines whether an end-of-exchange message has been received from all SXP speakers. The end-of-exchange message indicates to the first node that the first node has received the necessary IP-to-SGT bindings. The necessary IP-to-SGT bindings include all IP-to-SGT bindings required to obtain the source SGTs (which may be added to the incoming traffic) and/or the destination SGTs (which are used to apply the correct SGACL policies to the traffic). If, at step 660, the first node determines that it has not received all IP-to-SGT bindings, method 600 moves back to step 650, where the first node continues to receive IP-to-SGT bindings. Once the first node receives the end-of-exchange message from the last SXP speaker, method 600 moves from step 660 to step 670, where the routing protocol costs in the first node. Costing in the first node allows the IP traffic to flow through the first node. Method 600 then moves from step 670 to step 680, where method 600 ends.

Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for costing in nodes after policy plane convergence including the particular steps of the method of FIG. 6, this disclosure contemplates any suitable method for costing in nodes after policy plane convergence including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

Although FIGS. 1 through 6 describe systems and methods for costing in nodes after policy plane convergence using SXP, these approaches can be applied to any method of provisioning policy plane bindings on a node. For example, this approach may be applied to NETCONF, CLI, or any other method that provisions the mappings of flow classification parameters (e.g. source, destination, protocol, port, etc.) to the security/identity tracking mechanism bindings. The policy plane converges when all the flow classification parameters to security/identity tracking mechanism bindings are determined and programmed by the new, upcoming node.

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A first network apparatus, comprising:
one or more processors; and
one or more computer-readable non-transitory storage media coupled to the one or more processors and comprising instructions that, when executed by the one or more processors, cause the first network apparatus to perform operations comprising:
activating the first network apparatus within a network;
determining that a Scalable Group Tag (SGT) Exchange Protocol (SXP) is configured on the first network apparatus;
costing out the first network apparatus in response to determining that the SXP is configured on the first network apparatus, wherein costing out the first network apparatus prevents Internet Protocol (IP) traffic from flowing through the first network apparatus;
receiving IP-to-SGT bindings from an SXP speaker;
receiving an end-of-exchange message from the SXP speaker; and
costing in the first network apparatus in response to receiving the end-of-exchange message, wherein costing in the first network apparatus allows the IP traffic to flow through the first network apparatus.

2. The first network apparatus of claim 1, wherein:
the first network apparatus is a first fabric border node of a first software-defined (SD) access site;
the IP traffic flows through a second fabric border node of the first SD access site prior to costing in the first fabric border node of the first SD access site;
the IP traffic is received by the second fabric border node from an edge node of the first SD access site; and
the IP traffic is received by the edge node of the first SD access site from an edge node of a second SD access site using Layer 3 virtual private network (L3VPN).

3. The first network apparatus of claim 2, wherein the SXP speaker is associated with a fabric border node within the second SD access site.

4. The first network apparatus of claim 1, wherein:
the first network apparatus is a first fabric border node of a first SD access site;
the IP traffic flows through a second fabric border node of the first SD access site prior to costing in the first fabric border node of the first SD access site;
the IP traffic is received by the second fabric border node from an edge node of the first SD access site;
the IP traffic is received by the edge node of the first SD access site from an edge node of a second SD access site using a wide area network (WAN); and
the SXP speaker is associated with an identity services engine (ISE).

5. The first network apparatus of claim 1, wherein:
the first network apparatus is a first edge node of a first site;
the IP traffic flows through a second edge node of the first site prior to costing in the first edge node of the first site;
the IP traffic is received by the second edge node from an edge node of a second site using WAN; and
the SXP speaker is associated with an ISE.

6. The first network apparatus of claim 1, wherein:
the first network apparatus is a first edge node of a branch office;
the IP traffic flows through a second edge node of the branch office prior to costing in the first edge node of the branch office;
the IP traffic is received by the second edge node of the branch office from an edge node of a head office using WAN; and
the SXP speaker is associated with the edge node of the head office.

7. The first network apparatus of claim 1, wherein a routing protocol initiates costing out the first network apparatus and costing in the first network apparatus.

8. A method, comprising:
activating a first network apparatus within a network;
determining, by the first network apparatus, that a Scalable Group Tag (SGT) Exchange Protocol (SXP) is configured on the first network apparatus;
costing out the first network apparatus in response to determining that the SXP is configured on the first network apparatus, wherein costing out the first network apparatus prevents Internet Protocol (IP) traffic from flowing through the first network apparatus;
receiving, by the first network apparatus, IP-to-SGT bindings from an SXP speaker;
receiving, by the first network apparatus, an end-of-exchange message from the SXP speaker; and
costing in the first network apparatus in response to receiving the end-of-exchange message, wherein costing in the first network apparatus allows the IP traffic to flow through the first network apparatus.

9. The method of claim 8, wherein:
the first network apparatus is a first fabric border node of a first software-defined (SD) access site;
the IP traffic flows through a second fabric border node of the first SD access site prior to costing in the first fabric border node of the first SD access site;
the IP traffic is received by the second fabric border node from an edge node of the first SD access site; and
the IP traffic is received by the edge node of the first SD access site from an edge node of a second SD access site using Layer 3 virtual private network (L3VPN).

10. The method of claim 9, wherein the SXP speaker is associated with a fabric border node within the second SD access site.

11. The method of claim 8, wherein:
the first network apparatus is a first fabric border node of a first SD access site;
the IP traffic flows through a second fabric border node of the first SD access site prior to costing in the first fabric border node of the first SD access site;
the IP traffic is received by the second fabric border node from an edge node of the first SD access site;
the IP traffic is received by the edge node of the first SD access site from an edge node of a second SD access site using a wide area network (WAN); and
the first fabric border node of the first SD access site determines the IP-to-SGT bindings from an identity services engine (ISE).

12. The method of claim 8, wherein:
the first network apparatus is a first edge node of a first site;
the IP traffic flows through a second edge node of the first site prior to costing in the first edge node of the first site;
the IP traffic is received by the second edge node from an edge node of a second site using WAN; and
the SXP speaker is associated with an ISE.

13. The method of claim 8, wherein:
the first network apparatus is a first edge node of a branch office;
the IP traffic flows through a second edge node of the branch office prior to costing in the first edge node of the branch office;
the IP traffic is received by the second edge node of the branch office from an edge node of a head office using WAN; and
the SXP speaker is associated with the edge node of the head office.

14. The method of claim 8, wherein a routing protocol initiates costing out the first network apparatus and costing in the first network apparatus.

15. One or more computer-readable non-transitory storage media embodying instructions that, when executed by a processor, cause the processor to perform operations comprising:
activating a first network apparatus within a network;
determining that a Scalable Group Tag (SGT) Exchange Protocol (SXP) is configured on the first network apparatus;
costing out the first network apparatus in response to determining that the SXP is configured on the first network apparatus, wherein costing out the first network apparatus prevents Internet Protocol (IP) traffic from flowing through the first network apparatus;
receiving IP-to-SGT bindings from an SXP speaker;
receiving an end-of-exchange message from the SXP speaker; and
costing in the first network apparatus in response to receiving the end-of-exchange message, wherein costing in the first network apparatus allows the IP traffic to flow through the first network apparatus.

16. The one or more computer-readable non-transitory storage media of claim 15, wherein:
the first network apparatus is a first fabric border node of a first software-defined (SD) access site;
the IP traffic flows through a second fabric border node of the first SD access site prior to costing in the first fabric border node of the first SD access site;
the IP traffic is received by the second fabric border node from an edge node of the first SD access site; and
the IP traffic is received by the edge node of the first SD access site from an edge node of a second SD access site using Layer 3 virtual private network (L3VPN).

17. The one or more computer-readable non-transitory storage media of claim 16, wherein the SXP speaker is associated with a fabric border node within the second SD access site.

18. The one or more computer-readable non-transitory storage media of claim 15, wherein:
the first network apparatus is a first fabric border node of a first SD access site;
the IP traffic flows through a second fabric border node of the first SD access site prior to costing in the first fabric border node of the first SD access site;
the IP traffic is received by the second fabric border node from an edge node of the first SD access site;
the IP traffic is received by the edge node of the first SD access site from an edge node of a second SD access site using a wide area network (WAN); and
the first fabric border node of the first SD access site determines the IP-to-SGT bindings from an identity services engine (ISE).

19. The one or more computer-readable non-transitory storage media of claim 15, wherein:
the first network apparatus is a first edge node of a first site;
the IP traffic flows through a second edge node of the first site prior to costing in the first edge node of the first site;
the IP traffic is received by the second edge node from an edge node of a second site using WAN; and
the SXP speaker is associated with an ISE.

20. The one or more computer-readable non-transitory storage media of claim 15, wherein:
the first network apparatus is a first edge node of a branch office;
the IP traffic flows through a second edge node of the branch office prior to costing in the first edge node of the branch office;
the IP traffic is received by the second edge node of the branch office from an edge node of a head office using WAN; and
the SXP speaker is associated with the edge node of the head office.
